(19) United States
(12) Patent Application Publication
(10) Pub. No.: US 2026/0169934 A1
(43) Pub. Date: Jun. 18, 2026

(54) STORING DATA IN A PERIPHERAL DEVICE

(71) Applicant: INTERNATIONAL BUSINESS MACHINES CORPORATION, ARMONK, NY (US)

(72) Inventors: Marco Kraemer, Sindelfingen (DE); Christoph Raisch, Gerlingen (DE); Jens Mehler, Ehningen (DE)

(21) Appl. No.: 19/045,873

(22) Filed: Feb. 5, 2025

(30) Foreign Application Priority Data
Dec. 16, 2024 (GB) 2418399.8

(51) Int. Cl. G06F 13/16; G06F 9/30; G06F 13/28

(52) U.S. Cl. CPC G06F 13/1642; G06F 9/30043; G06F 13/1689; G06F 13/28

(57) ABSTRACT

A method for storing data in a peripheral device is provided, the peripheral device being configured to connect to a processing subsystem, the processing subsystem comprising a processing unit and a memory unit. The method includes: providing the memory unit with a queue, and repeatedly performing by the processing unit: receiving a store instruction to store data in the peripheral device; adding an entry in the queue, the entry representing the store instruction; and in response to determining that a trigger condition is fulfilled, enabling the bus controller to access the store instructions being in the queue.

### BACKGROUND

The present disclosure relates to field of digital computer systems, and more specifically, to a method for storing data in a peripheral device.

In modern computer systems, the efficient communication between the central processing unit (CPU) and peripheral devices may be vital for high performance, often managed through Peripheral Component Interconnect (PCI) technology. A typical PCI-based system may consist of a processing subsystem, including the CPU and memory, connected to a PCI Root Complex, which handles data transfers between the processing subsystem and various PCI devices like storage or network adapters.

### SUMMARY

Various embodiments provide a method for storing data in a peripheral device, computer program product and computer system as described by the subject matter of the independent claims. Advantageous embodiments are described in the dependent claims. Embodiments of the present disclosure can be freely combined with each other if they are not mutually exclusive.

In one aspect, the disclosure relates to a method for storing data in a peripheral device, the peripheral device being configured to connect to a processing subsystem through a bus controller, the processing subsystem comprising a processing unit and a memory unit; the method comprising: providing the memory unit with a queue; repeatedly performing by the processing unit: receiving a store instruction to store data in the peripheral device; adding an entry in the queue, the entry representing the store instruction; in response to determining that a trigger condition is fulfilled, enabling the bus controller to access the store instructions being in the queue.

In one aspect the disclosure relates to a computer program product comprising a computer-readable storage medium having computer-readable program code embodied therewith, the computer-readable program code configured to implement the method of the above embodiment.

In one aspect, the disclosure relates to a processing unit for a computer system for storing data in a peripheral device, the peripheral device being configured to connect through a bus controller to the processing unit, the computer system comprising the bus controller, the processing unit and a memory unit, the memory unit comprising a queue; the processing unit being configured for: repeatedly: receiving a store instruction to store data in the peripheral device; adding an entry in the queue, the entry representing the store instruction; and in response to determining that a trigger condition is fulfilled, enabling the bus controller to access the store instructions being in the queue.

The above summary is not intended to describe each illustrated embodiment or every implementation of the present disclosure.

### BRIEF DESCRIPTION OF THE DRAWINGS

In the following, embodiments of the disclosure are explained in greater detail, by way of example only, making reference to the drawings in which:

FIG. 1 is a diagram of a computer system in accordance with an example of the present disclosure.

FIG. 2 is a flowchart of a method for storing data in a peripheral device, in accordance with an example of the present disclosure.

FIG. 3 is a flowchart of a method for storing data in a peripheral device, in accordance with an example of the present disclosure.

FIG. 4 is a flowchart of a method for storing data in a peripheral device, in accordance with an example of the present disclosure.

FIG. 5 is a diagram illustrating a method for enabling access to store instructions to the bus controller in accordance with an example of the present disclosure.

FIG. 6 is a diagram illustrating a method for sending pokes for enabling access to store instructions to the bus controller in accordance with an example of the present disclosure.

FIG. 7 is a diagram illustrating catchline content of a trigger queue in accordance with an example of the present disclosure.

FIG. 8 is a computing environment in accordance with an example of the present disclosure.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

The descriptions of the various embodiments of the present disclosure will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present subject matter employs asynchronous mechanisms through the use of a queue in memory, working in coordination with a bus controller. This approach may significantly increase system flexibility, enabling smoother adaptation to varying workloads while ensuring optimal performance. For instance, the present subject matter may enhance system efficiency and reduce latency by allowing multiple instructions to be queued and processed at optimal times, minimizing idle periods and providing faster response times compared to sequential processing. Additionally, it may improve resource utilization by enabling concurrent tasks, resulting in better scalability and the ability to manage larger data volumes effectively.

A processing subsystem may be provided. The processing subsystem may be comprised in a computer system. The processing subsystem may comprise at least one processing unit and a memory unit. The processing unit may, for example, comprise a CPU. The processing subsystem may be configured to connect to a peripheral device via a bus interface such as a Universal Serial Bus (USB) or PCI interface. The peripheral device may be an external device to enhance functionality of the processing subsystem, allowing for data input, output, storage, and connectivity with other systems or networks. The peripheral device may, for example, be an input device (e.g., keyboards, mice), an output device (e.g., monitors, printers), a storage device (e.g., external hard drives, USB drives), or a communication device (e.g., network cards, modems). The peripheral device may, for example, be associated with a device driver. The device driver may be a software that allows an operating system of the computer system and other software applications to communicate with and control the peripheral device. The device driver may act as a translator between the peripheral device and the operating system, converting high-level commands from software into low-level instructions that the peripheral device can understand and execute.

A hardware component may be provided to manage the communication between the processing subsystem and the peripheral device. The hardware component may be referred to as bus controller. The bus controller may facilitate communication and data transfer between the processing subsystem and the peripheral device. The bus controller may act as a mediator, managing data flow and ensuring that different parts can communicate efficiently without conflicts. In the context of Peripheral Component Interconnect Express (PCIe), the bus controller may be referred to as the Root Complex that connects the processing subsystem to the PCIe bus, translating requests and data between the processor subsystem and the peripheral device which is a PCIe device.

During operation, the bus controller may be configured to receive a trigger, consisting of a specific command or signal sent by the processing unit in response to control by a device driver or a software application. Triggers may act as requests that prompt the bus controller to execute necessary tasks, enabling the processing subsystem to interact with connected devices and carry out required functions. The present subject matter may efficiently manage trigger handling and therefore operation control for storing data on the peripheral device. For that, the memory unit may be provided with a queue. The memory unit may include the queue. The queue may, for example, be a specific region in the memory unit where entries representing pending store instructions are temporarily stored. This structure may allow for time efficient batching of operations. The queue may be referred to as a 'trigger queue' for naming purposes, as it may be utilized in response to triggers.

The processing unit may be configured to repeatedly perform a data storage operation. The data storage operation comprises: receiving a store instruction to store data in the peripheral device, adding an entry in the trigger queue, the entry representing the store instruction, and in response to determining that a trigger condition is fulfilled, enabling the bus controller to access the store instructions being in the trigger queue. The processing unit may be configured to fetch specific instructions (e.g., provided by a device driver or software application) which are stored in the memory unit in order to perform the present method.

“Repeatedly perform a data storage operation" may refer to the processing unit's ability to continuously execute the data storage operation whenever a store instruction is received. This may mean that the processing unit may handle multiple storage instructions over time, adding entries to the trigger queue and processing them as needed, based on predefined conditions. The repetition may continue indefinitely as long as there are new store instructions to be processed, indicating that the system does not stop but rather operates in an ongoing loop.

The processing unit may receive the store instruction, which initiates the data storage by directing to store data in the peripheral device. This store instruction may originate from software, such as the device driver, or from higher-level application requests.

Upon receiving the store instruction, the processing unit creates an entry in the trigger queue. The entry may, for example, be descriptive of the store instruction. Hence, the trigger queue may buffer store instructions, allowing the processing subsystem to batch process them instead of handling each store instruction immediately. This may reduce processing overhead by enabling bulk data transfers, significantly improving system performance compared to processing individual store instructions sequentially.

The processing unit may be configured to monitor whether the trigger condition, such as the queue reaching a specific number of entries, a time interval elapsing, system resource availability, or a signal is received, has been met. This trigger condition may serve as a checkpoint that indicates when to enable access to the queued store instructions, optimizing system efficiency. For instance, instead of engaging the bus controller for each individual store instruction, the present subject matter may wait until multiple store instructions are queued, reducing unnecessary bus access. This approach may minimize bus traffic.

In response to determining that the trigger condition is met, the processing unit enables the bus controller to access the store instructions being in the trigger queue.

For example, in response to determining that the trigger condition has been met, the processing unit may grant the bus controller access to the store instructions in the trigger queue. This step may allow the bus controller to retrieve or receive and then process the retrieved or received queued instructions for execution.

In one example (referred to a first access approach), enabling access to each store instruction may comprise the enabling access to the store instruction and data that needs to be stored by said store instruction. Alternatively (referred to a second access approach), enabling access to the store instruction may involve only enabling access to the store instruction itself, with the associated data to be stored being fetched or processed separately at a later stage. This flexibility may allow the present subject matter to optimize resource management by either transferring both the instruction and data together or by handling them in a more staggered manner, based on performance needs.

Hence, the present subject matter may provide an efficient, scalable approach to managing data storage operations in peripheral devices.

According to one example, enabling access to the store instructions comprises sending a trigger, referred to as a delayed trigger, to the bus controller, thereby triggering the bus controller to fetch the store instructions from the trigger queue. The trigger may, for example, be a signal.

For example, the delayed trigger signals the bus controller to fetch the store instructions from the trigger queue for processing. The delayed trigger may ensure that the system waits for optimal conditions before initiating the execution of store operations. This mechanism may allow the bus controller to handle multiple instructions at once for efficient transfer of data. Upon receiving the delayed trigger, the bus controller may retrieve and process the store instructions accumulated in the trigger queue. This may enable to initiate communication with the peripheral device to transfer the specified data.

With the first access approach, the bus controller may fetch both the store instruction and its associated data simultaneously. In contrast, with the second access approach, the bus controller may only fetch the store instruction, with the associated data being retrieved separately at a later stage. The later retrieval may be triggered or requested by the peripheral device.

According to one example, the method further comprises: upon receiving a first store instruction or a store instruction following the submission of the delayed trigger, setting a timer to a time delay and starting the timer, wherein the trigger condition is an expiration of the timer.

The trigger condition for sending the delayed trigger is the expiration of the timer. Once the timer expires, the processing unit sends the delayed trigger to the bus controller, instructing it to process store instructions accumulated in the trigger queue. The timer may enable to wait before executing the transfer, allowing multiple store instructions to accumulate, rather than processing each one immediately.

The timer may be a hardware device or software function that measures time intervals, either by counting up or down from a specified value. In one example implementation, the timer may be a built-in timer of the processing unit. For example, when the timer is counting down, it expires when it reaches zero e.g., at which point it may signal the processing unit indicating that the trigger condition is fulfilled.

Indeed, upon receiving a specific store instruction, the timer may be set with the time delay and started immediately. This specific store instruction may be the first store instruction in the data storage operation that is received before any delayed trigger has been sent by the processing unit to the bus controller. Alternatively, the specific store instruction may be the first store instruction received by the processing unit immediately after each delayed trigger is sent to the bus controller.

According to one example, the method further comprises determining using a fill state indicator whether the trigger queue is full, and in response to determining that the trigger queue is full, determining that the timer is prematurely expired for prematurely sending the delayed trigger.

The fill state indicator may enable to track the current capacity of the trigger queue and may be implemented in different ways. The fill state indicator may, for example, function as a counter that increments with each new store instruction added. For example, if the trigger queue may hold 10 store instructions and 9 have already been added, the fill state indicator may show that the trigger queue is nearly full, 90% full.

With this example, the processing unit may force the timer to expire before it naturally reaches zero, ensuring that the delayed trigger is sent to the bus controller to process the store instructions currently in the trigger queue. This override mechanism may allow the timer’s expiration to be triggered by certain conditions, such as the fullness of the trigger queue. Indeed, while the timer may usually control when the instructions are processed, a full queue takes precedence according to this example. This early expiration may prioritize the queue's capacity over the timer's original schedule.

In response to the timer being considered prematurely expired, this may indicate that the trigger condition is fulfilled and thus the processing unit sends the delayed trigger to the bus controller.

By using a combination of queue monitoring and timer expiration, this example may ensure that store instructions are handled efficiently and promptly, optimizing system performance while preventing resource overload.

According to one example, the time delay is a preset amount of time or an implicit delay of a communication between the processing unit and the bus controller.

Indeed, the time delay (e.g., which is the period or duration of the timer) may either be a preset amount of time, which is a predefined fixed interval, or an implicit delay that may naturally occur due to communication latencies between the processing unit and the bus controller. A preset delay may allow for consistent and predictable timing, ensuring that store instructions are processed at regular intervals. In contrast, an implicit delay may leverage the inherent communication overhead, dynamically adjusting the timing based on real-time conditions without the need for explicit timing.

According to one example, the trigger condition is any one of: a reception of a signal from the bus controller or the trigger queue being full. The signal may be sent from the bus controller to the processing unit, indicating that the bus controller is ready to process the queued store instructions. The signal may trigger the processing unit to send store instructions which are in the trigger queue to the bus controller. The signal may also be referred to as poke or poke signal.

For example, the trigger condition may be defined as either the reception of a signal from the bus controller or the trigger queue being full. This condition may allow the processing unit to send the delayed trigger when the bus controller explicitly signals readiness, ensuring synchronization. Alternatively, the trigger condition may also occur when the trigger queue is full, meaning it has reached its maximum capacity of store instructions. In this case, the processing unit may automatically send the delayed trigger to prevent queue overflow and to ensure timely processing of the accumulated store instructions.

According to one example, the trigger condition is a reception of a signal from the bus controller, wherein enabling access to the store instructions comprises sending the store instructions to the bus controller.

The trigger condition in this example is the reception of a signal from the bus controller, indicating that the bus controller is ready to process the store instructions. Upon receiving this signal, the processing unit enables access to the store instructions by sending them directly to the bus controller. With the first access approach, the processing unit may send both the store instruction and its associated data simultaneously. In contrast, in the second access approach, the processing unit may only send the store instruction, with the associated data being retrieved separately at a later stage by the bus controller.

According to one example, the processing unit is configured to set a first flag indicating a signal is required, wherein the bus controller is configured to set a second flag and send the signal to the processing unit in response to determining that the first flag is set. The first flag may, for example, comprise one or more bits. The second flag may, for example, comprise one or more bits. Setting the second flag may indicate that the bus controller has recognized the signal as needed by the processing unit. Specifically, setting the second flag may serve as an acknowledgment to the processing unit that the signal has been initiated. At this point, the processing unit may, for example, reset (or clear) the first flag or wait for the bus controller to reset it, depending on the configuration. In an alternative example, a single flag may be used, where the processing unit may set the flag to indicate that a signal is required. The bus controller, upon detecting this flag being set, may send the signal to the processing unit and subsequently reset (or clear) the flag to acknowledge receipt.

The first flag may serve as a signal to the bus controller, prompting it to initiate communication. Upon detecting that the first flag is set, the bus controller may set the second flag and send a signal to the processing unit, indicating its readiness to proceed with the next step of processing store instructions.

This interaction may ensure efficient coordination between the processing unit and the bus controller, allowing the bus controller to access by receiving store instructions when necessary, based on the first and second flags’ status, optimizing system performance and reducing unnecessary communication.

According to one example, the processing unit is configured to set the first flag in response to determining that the trigger queue has a filling status exceeding a threshold.

For example, the processing unit is configured to set the flag when it determines that the filling status of the trigger queue has fallen below the threshold. This flag indicates that the trigger queue has available capacity. This mechanism may help maintain optimal performance by triggering the bus controller to act only when additional data or instructions can be handled efficiently.

For example, the step of checking the trigger condition and thus enabling access to the store instruction may be implemented as follows. A sender operation may be performed by the processing unit, wherein the sender operation may comprise: upon receiving a signal from the bus controller enabling access to a given number of store instructions by the processing unit to the bus controller. This given number of store instructions may be all store instructions present in the trigger queue or a certain percentage of them. During the sender operation, the first flag may not be set. Upon determining that the sender operation is completed (i.e., all given store instructions are provided to the bus controller), the processing unit may set the first flag. In parallel to the sender operation, the bus controller may perform a receiver operation. The receiver operation may comprise receiving the store instructions while the first flag is not set, and upon determining that the first flag is set: send a signal to the processing unit and set the second flag, so the processing unit may further enable access to other queued store instruction through the sender operation. Optionally, while the first flag is set and the signal is not received yet the processing unit may still provide some store instructions to the bus controller.

According to one example, the processing subsystem comprises multiple bus controllers each being associated with a peripheral device, wherein the method further comprises providing the memory unit with a trigger queue per bus controller, wherein the adding of the entry comprises selecting the trigger queue based on the store instruction. The memory unit comprises multiple trigger queues associated with the pairs bus controller-peripheral device respectively.

In this example, the processing subsystem includes multiple bus controllers, each linked to a specific peripheral device (such as storage, network, or display devices). The method may involve assigning a separate trigger queue to each bus controller in the memory unit, ensuring that store instructions for different peripherals are managed independently. When a store instruction is received, the processing unit selects the appropriate trigger queue based on which bus controller and peripheral device the store instruction is intended for. This may allow each bus controller to handle its specific set of queued instructions without interference from other controllers, optimizing parallel processing and data management. This may prevent bottlenecks and improve the performance of operations across multiple peripherals simultaneously.

According to one example, the processing subsystem comprises multiple bus controllers each being associated with a peripheral device, wherein the entry descriptive of the store instruction in the trigger queue further comprises an indication of the peripheral device, and of the bus controller the store instruction is intended for.

In this example, the processing subsystem includes multiple bus controllers, each linked to a specific peripheral device. When a store instruction is added to the trigger queue, the entry may not only contain the details of the store instruction but also includes an indication of the specific peripheral device and the associated bus controller that will handle the store instruction. This may ensure that the processing unit can accurately route and manage data to the correct peripheral through its designated bus controller, reducing the risk of misrouting. By incorporating both the peripheral device and bus controller information into each entry, the processing unit may efficiently coordinate data transfers across multiple devices, ensuring that the appropriate bus controller is activated for each specific task.

According to one example, the entry is stored as cacheline in a cache of the memory unit.

In this example, the entry representing a store instruction is stored as a cacheline in the cache of the memory unit. A cacheline may be a fixed-size block of data in the cache that allows for fast access to frequently used information.

According to one example, the method further comprises in response to receiving the delayed trigger by the bus controller, retrieving store instructions from the trigger queue, forwarding the store instructions to the peripheral device and fetching by the peripheral device data from the memory unit through Direct Memory Access (DMA) requests, and storing the fetched data. This example may advantageously be implemented with the second access approach.

For example, upon receiving the delayed trigger from the processing unit, the bus controller retrieves the store instructions from the trigger queue. These instructions may indicate what data needs to be transferred to the associated peripheral device. The bus controller then forwards these instructions to the peripheral device, initiating the process. The forwarding of the store instruction may comprise formatting the store instruction in a way that is interpretable by the peripheral device, ensuring compatibility and proper execution. This may involve converting the store instruction into a protocol or data format that the peripheral device can process and act upon effectively. Following this, and for each received instruction from the bus controller, the peripheral device may use one or more DMA requests to autonomously fetch, via the bus controller, the required data, associated with the received instruction, directly from the memory unit without continuous involvement of the processing unit. Each DMA request may first be sent to the bus controller. The bus controller then fetches data from the memory unit and then send it back to the peripheral device as a response to the DMA request. Once the peripheral device retrieves the data through DMA, it may proceed to store the fetched data in its designated location. This method may ensure efficient and high-speed data transfers by offloading memory access and data movement to the DMA process, reducing processing unit overhead and optimizing system performance by allowing parallel processing.

For example, for each store instruction, the bus controller may create one or more corresponding PCI Store Transaction Layer Packets (TLPs) and send the one or more PCI Store TLPs to the peripheral device, upon receiving the one or more PCI Store TLPs the peripheral device may perform one or more DMA requests through the bus controller in order to fetch the data associated with the one or more PCI Store TLPs form the memory unit through the bus controller.

According to one example, the method further comprises: while or after processing the trigger queue, the bus controller updates the fill state indicator of the trigger queue. Processing the trigger queue may comprise fetching or receiving store instructions from the trigger queue.

For example, while or after processing the trigger queue, the bus controller updates the fill state indicator. The fill state indicator reflects the current number of pending store instructions in the trigger queue. As the bus controller retrieves and processes each entry, it adjusts the fill state indicator to reflect the reduction in the trigger queue's load. This updated fill state information may be advantageous for the processing unit to determine whether new store instructions can be added to the trigger queue or if the trigger queue is nearing its capacity.

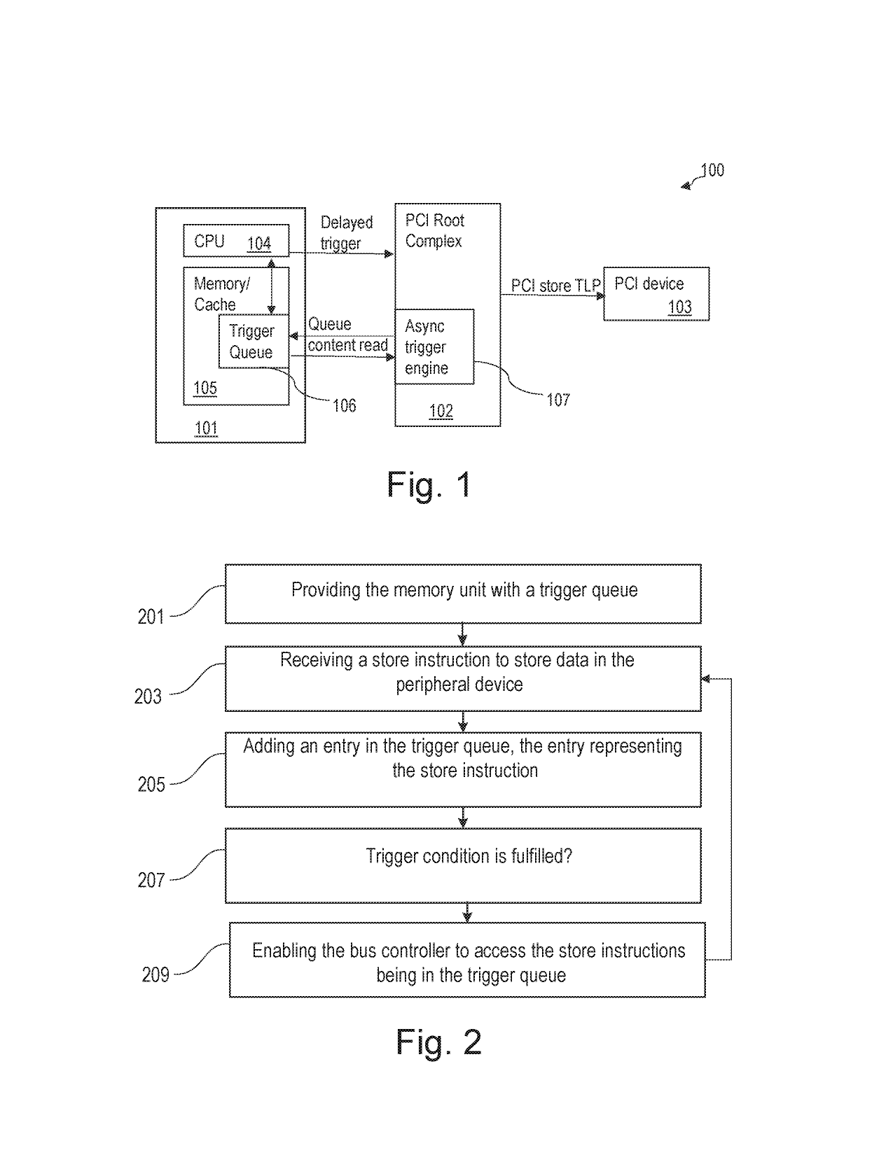

FIG. 1 is a diagram of a computer system in accordance with an example of the present subject matter.

The computer system 100 comprises a processing subsystem 101, a bus controller 102 and a peripheral device 103. The processing subsystem 101 comprises a processing unit 104 and a memory unit 105. In this example, the bus controller 102 is a PCI Root Complex, the peripheral device 103 is a PCI device, the processing unit 104 is one CPU and the memory unit 105 is a memory and/or cache. As shown, the memory unit 105 comprises a trigger queue 106. The trigger queue 106 may be used to queue store instructions which are received by the processing unit 104. The PCI Root Complex 102 comprises an engine referred to as async trigger engine 107.

The diagram illustrates an example interaction between components of the computer system 100. A device driver, running on the processing unit 104, may manage communication between an operating system of the computer system 100 and the peripheral device 103 by sending store instructions which are queued. In response to determining that a trigger condition is fulfilled, the processing unit 104 sends a delayed trigger to the async trigger engine 107. In response, the async trigger engine 107 reads the trigger content from the trigger queue 106 in the memory unit 105. The async trigger engine 107 generates one or more PCI Store TLPs based on the store instructions. The PCI Store TLPs may then transmitted from the bus controller 102 to the peripheral device 103.

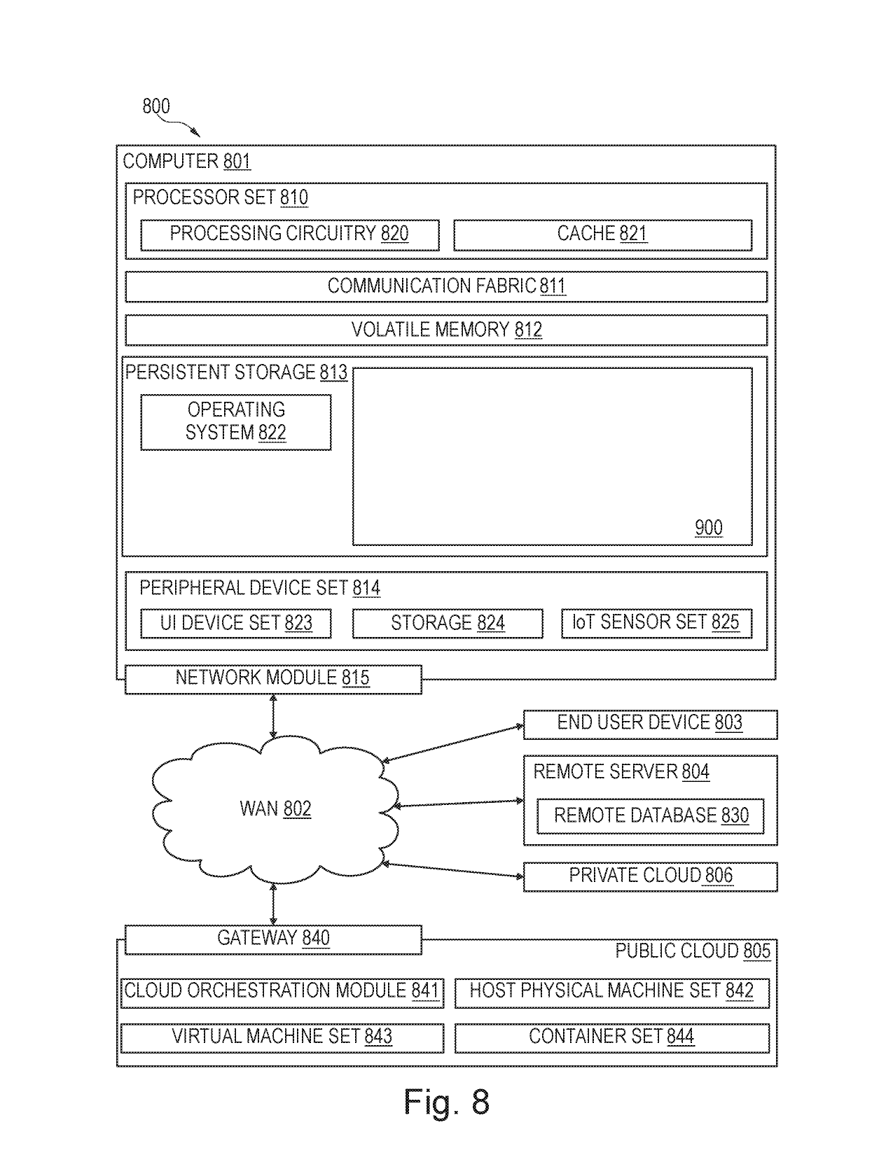

FIG. 2 is a flowchart of a method for storing data in a peripheral device, wherein the peripheral device is configured to connect, through a bus controller, to a processing subsystem comprising a processing unit and a memory unit. For the purpose of explanation, the method described in FIG. 2 may be implemented in the system illustrated in FIG. 1 or FIG. 8 but is not limited to this implementation. The method of FIG. 2 may, for example, be performed by the CPU 104 or processing circuitry 820 of FIG. 8.

The memory unit may be provided in step 201 with a queue.

In step 203, a store instruction to store data in the peripheral device may be received by the processing unit.

An entry may be added in step 205 in the queue. The entry represents the store instruction.

It may be determined in step 207 whether a trigger condition is fulfilled. If the trigger condition is fulfilled, the bus controller may be enabled in step 209 access to the store instructions being in the queue.

Steps 203 through 209 may be repeatedly performed.

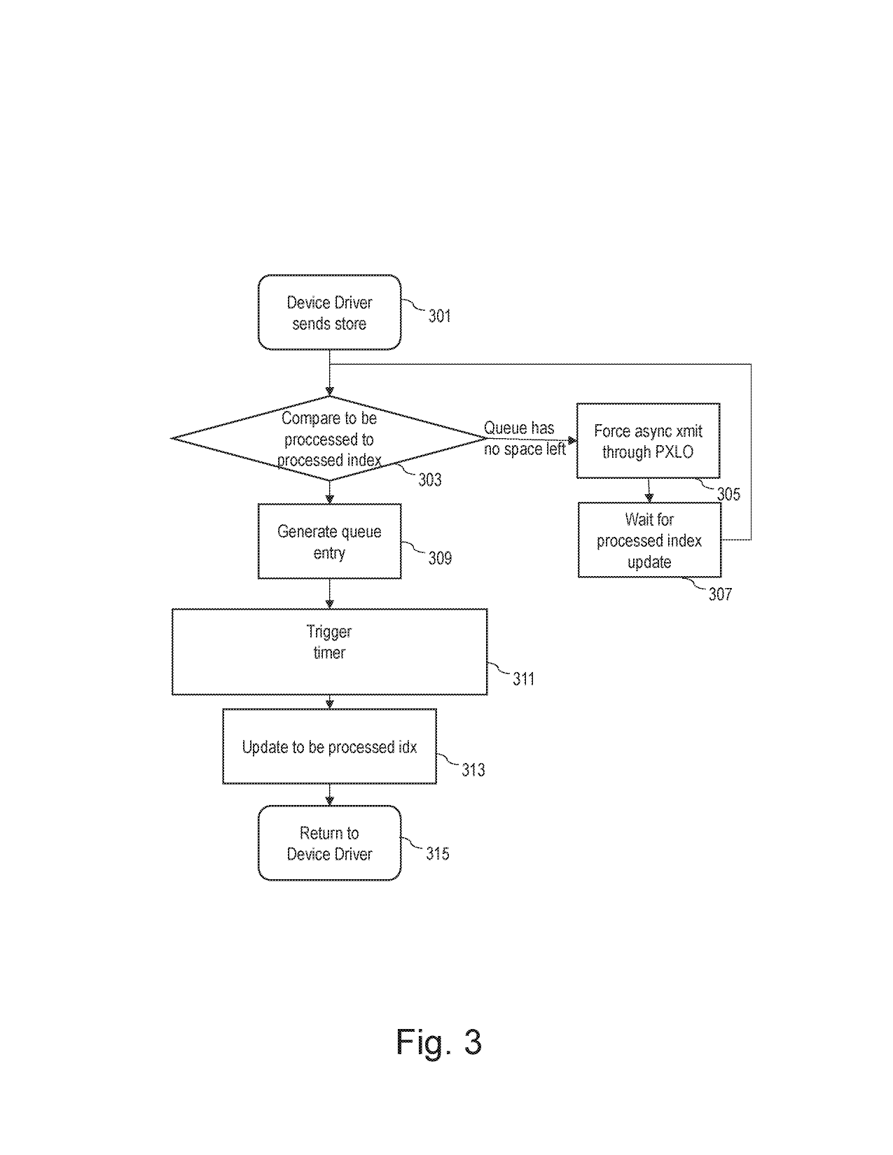

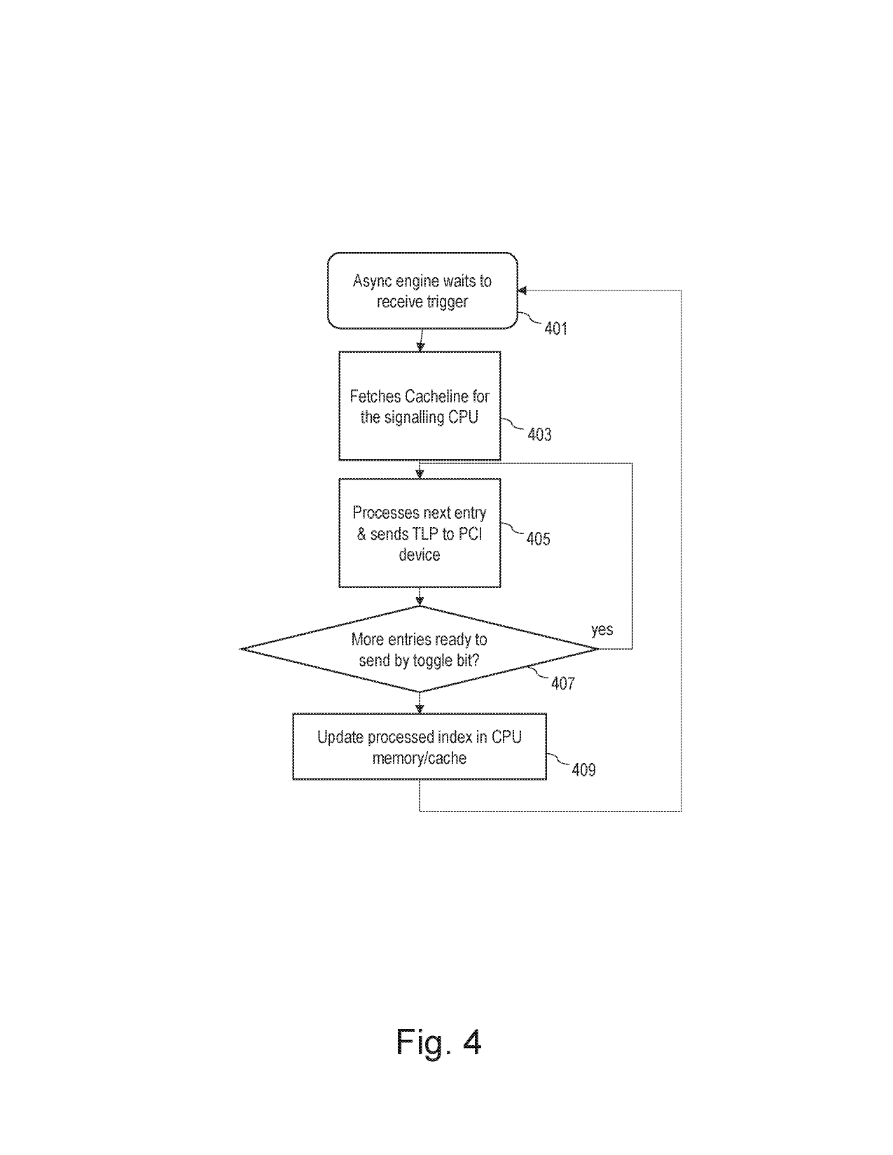

FIGS. 3 and 4 illustrate an example implementation of the method shown in FIG. 2, which enables access to store instructions queued in the trigger queue. The method in FIG. 3 may be executed by the CPU. The method of FIG. 4 may be executed by the async trigger engine. The method in FIG. 3 may repeatedly generate a trigger, which serves as input for the method in FIG. 4, allowing the async trigger engine to complete its execution as it awaits each trigger.

FIG. 3 is a flowchart of a method for storing data in a peripheral device, wherein the peripheral device is configured to connect, through a bus controller, to a processing subsystem comprising a processing unit and a memory unit. For the purpose of explanation, the method described in FIG. 3 may be implemented in the system illustrated in FIG. 1 or FIG. 8 but is not limited to this implementation. The method of FIG. 3 may, for example, be performed by the CPU 104 or processing circuitry 820 of FIG. 8.

The process begins when the device driver initiates in step 301 a store operation with the CPU 104. In step 303 the "to be processed" index may be compared with the "processed" index to determine if there is space left in the trigger queue. If the trigger queue has no space left, the process moves to steps 305 through 307; otherwise, it continues with step 309. The processed index may indicate processing status of the store instructions by the bus controller. The “to be processed” index and the “processed” index may provide an example implementation of the fill state indicator of the trigger queue.

If the trigger queue is full (as determined in step 303), an asynchronous transmission may be forced in step 305 through a mechanism identified as perform translator operation (PXLO). This may enable the bus controller to process the store instructions in the trigger queue. The CPU 104 then waits in step 307 for the processed index to update before proceeding back to step 303. This update may, for example, be initiated by the bus controller.

If space is available in the trigger queue (or after the forced asynchronous transmission), a new queue entry is generated in step 309. After generating the queue entry, the CPU 104 triggers in step 311 an asynchronous transmission timer e.g., again using the PXLO mechanism. This may enable the CPU 104 to check in step 311 whether the trigger condition is fulfilled and if so, it then enables access to store instructions to the bus controller in step 311.

The "to be processed" index is then updated in step 313, reflecting that the new entry has been added to the trigger queue and is awaiting processing. Finally, control is returned in step 315 to the device driver, signaling the end of this process loop.

FIG. 4 is a flowchart of a method for storing data in a peripheral device, wherein the peripheral device is configured to connect to a processing subsystem comprising a processing unit and a memory unit. For the purpose of explanation, the method described in FIG. 4 may be implemented in the system illustrated in FIG. 1 but is not limited to this implementation. The method of FIG. 4 may, for example, be performed by the async trigger engine 107.

The async trigger engine 107 may wait in step 401 to receive a delayed trigger. The process begins with the asynchronous engine waiting for a delayed trigger to initiate its operation. Once triggered, the async trigger engine 107 may fetch in step 403 the cache line(s) of the memory unit 105 associated with the CPU 104. The cachelines comprise store instructions. The async trigger engine 107 may process in step 405 to the next entry in the trigger queue, fetch the data, and send a TLP to the connected PCI device. The async trigger engine 107 may check in step 407 if there are more entries in the trigger queue that are ready to send e.g., as indicated by the toggle bits. The toggle bit may allow for determining whether the respective cacheline has been processed. If there are, the process loops back to step 405. If no more entries are ready, the async trigger engine 107 may update in step 409 the processed index in the CPU's memory or cache, marking the completion of the current processing cycle.

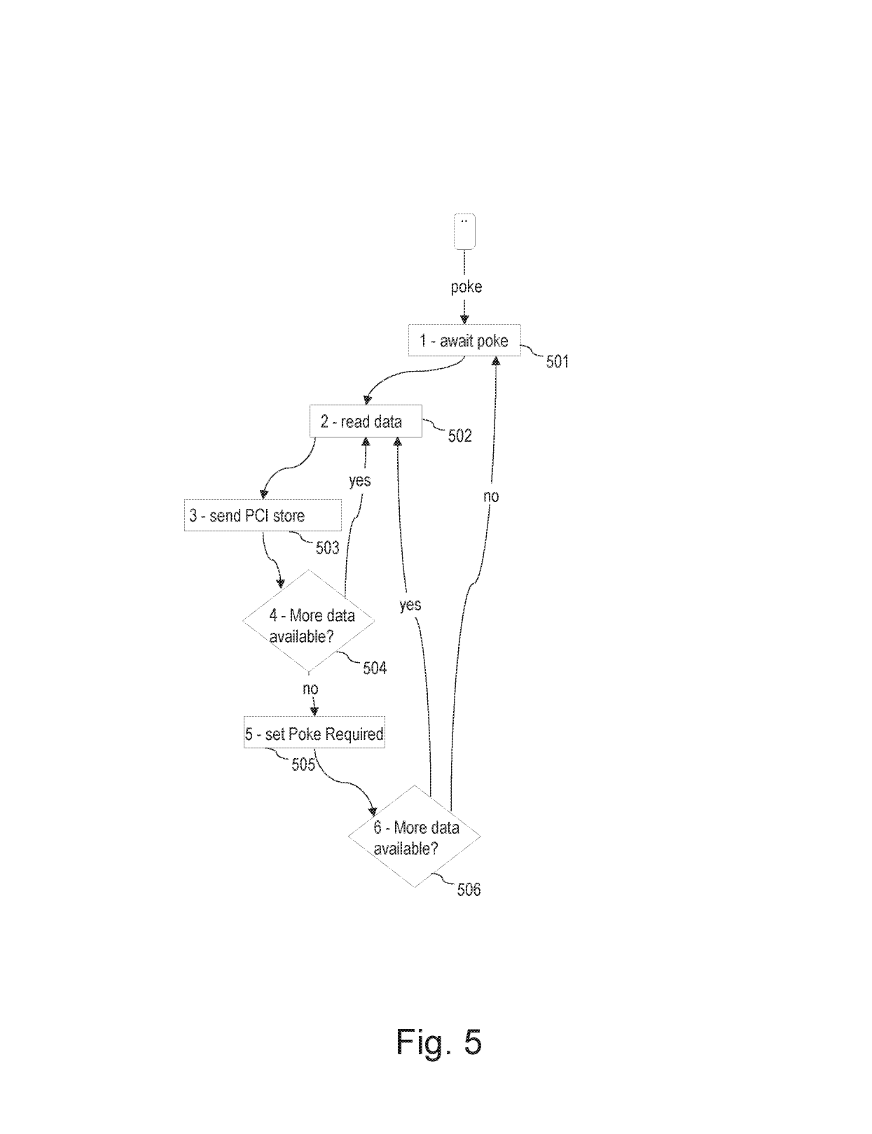

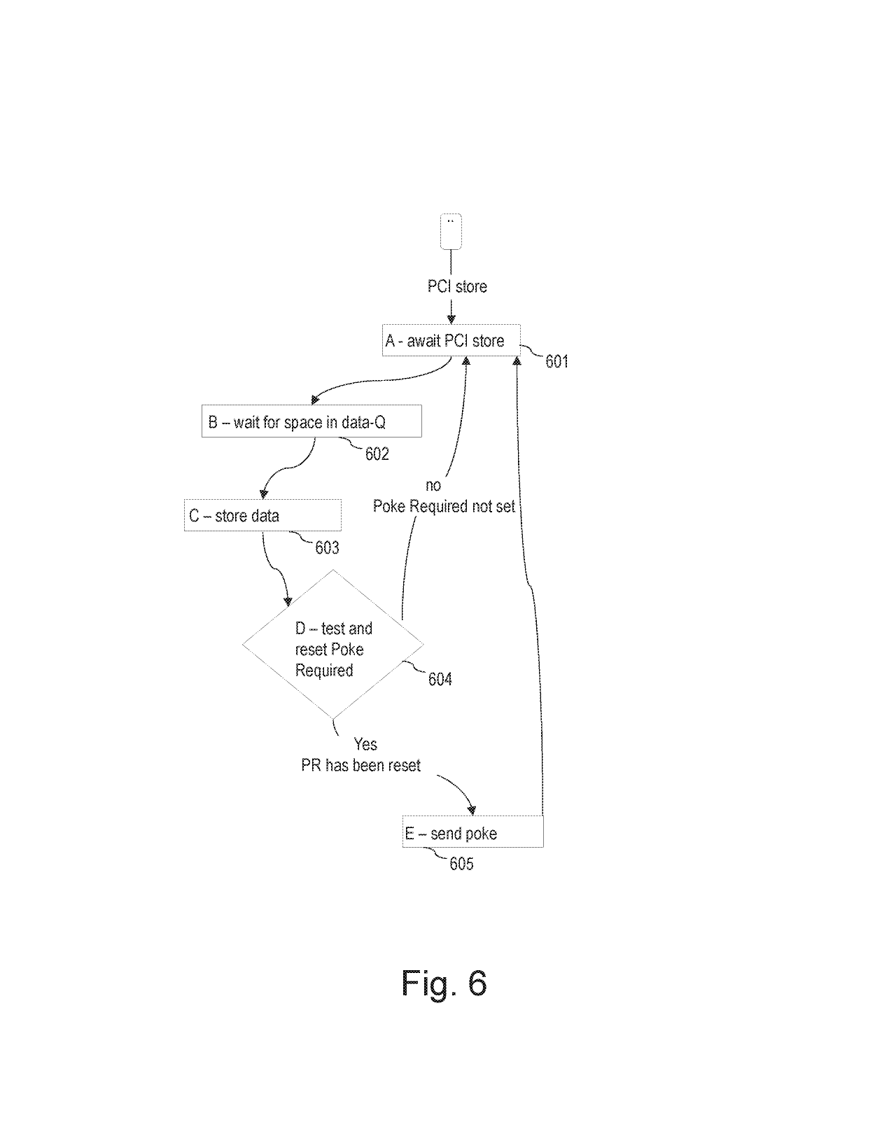

FIGS. 5 and 6 illustrate an example implementation of method steps 207 to 209 from FIG. 2, enabling access to store instructions queued in the trigger queue. Specifically, the method in FIG. 5 may serve as an alternative implementation for step 311 in FIG. 3, while the method in FIG. 6 may provide an alternative implementation for method steps 403 through 407 in FIG. 4. The method in FIG. 6 may repeatedly generate a poke, which serves as input for the method in FIG. 5, allowing the processing unit to complete its execution as it awaits each poke.

FIG. 5 is a diagram illustrating a method for enabling access to store instructions to the bus controller in accordance with an example of the present subject matter. For the purpose of explanation, the method described in FIG. 5 may be implemented in the system illustrated in FIG. 1 or FIG. 8 but is not limited to this implementation. The method of FIG. 5 may, for example, be performed by the CPU 104 or processing circuitry 820 of FIG. 8.

In step 501, the processing unit awaits a poke from the bus controller, which may be a signal indicating that the bus controller is ready for interaction. If no poke is received by the processing unit, the processing unit remains idle in this state. In step 502, after receiving the poke, the processing unit proceeds to read data from the trigger queue e.g., the data may comprise the store instruction for storage of specific data and optionally the specific data as well. If data is available in the trigger queue, the processing unit moves to step 503, where it sends PCI stores to the bus controller. In step 504, the processing unit checks whether more data (store instructions) in the trigger queue is available. If so, the processing unit loops back to read and process the next data stored in the trigger queue in step 502. If not, the processing unit proceeds to step 505, where the processing unit sets a Poke Required flag as an atomic operation, signaling that a new poke may be needed from the bus controller to continue processing store instructions by the CPU. Finally, in step 506, the processing unit checks once more if there is any additional data in the trigger queue. If data is available, the processing unit returns to the reading phase (step 502); otherwise, the processing unit waits for further instructions or signals. This loop may ensure the processing unit handles data efficiently, driven by poke signals and data availability.

FIG. 6 is a diagram illustrating a method for sending pokes for enabling access to store instructions to the bus controller in accordance with an example of the present subject matter. For the purpose of explanation, the method described in FIG. 6 may be implemented in the system illustrated in FIG. 1 but is not limited to this implementation. The method of FIG. 6 may, for example, be performed by the async trigger engine 107.

In step 601, the bus controller awaits a PCI store instruction, meaning it is waiting to receive instructions (and optionally data) from the processing unit upon sending a poke to the processing unit from the bus controller. In step 602, if there’s no space in the data queue (data-Q) used by the bus controller, the bus controller may wait for space to become available in its data-Q. This may ensure that the bus controller doesn’t try to store data when there’s no room left in the data queue. In step 603, once space becomes available in the data-Q, the bus controller stores the data from the PCI store into the data queue. In step 604, the bus controller may then check if the "Poke Required" flag is set by the processing unit. This step is an atomic operation, ensuring that no other actions may interfere while the flag is checked. If the flag has not been set, the method proceeds back to step 601. If the flag is set, it may indicate that a poke needs to be sent by the bus controller to the processing unit. In step 605, if the Poke Required flag was determined to be set in step 604, the bus controller proceeds to set another flag, which may be named “poke flag”, send a poke back to the processing unit and then proceeds back to step 601. This poke signals to the processing unit that the bus controller is ready for more data or further instructions.

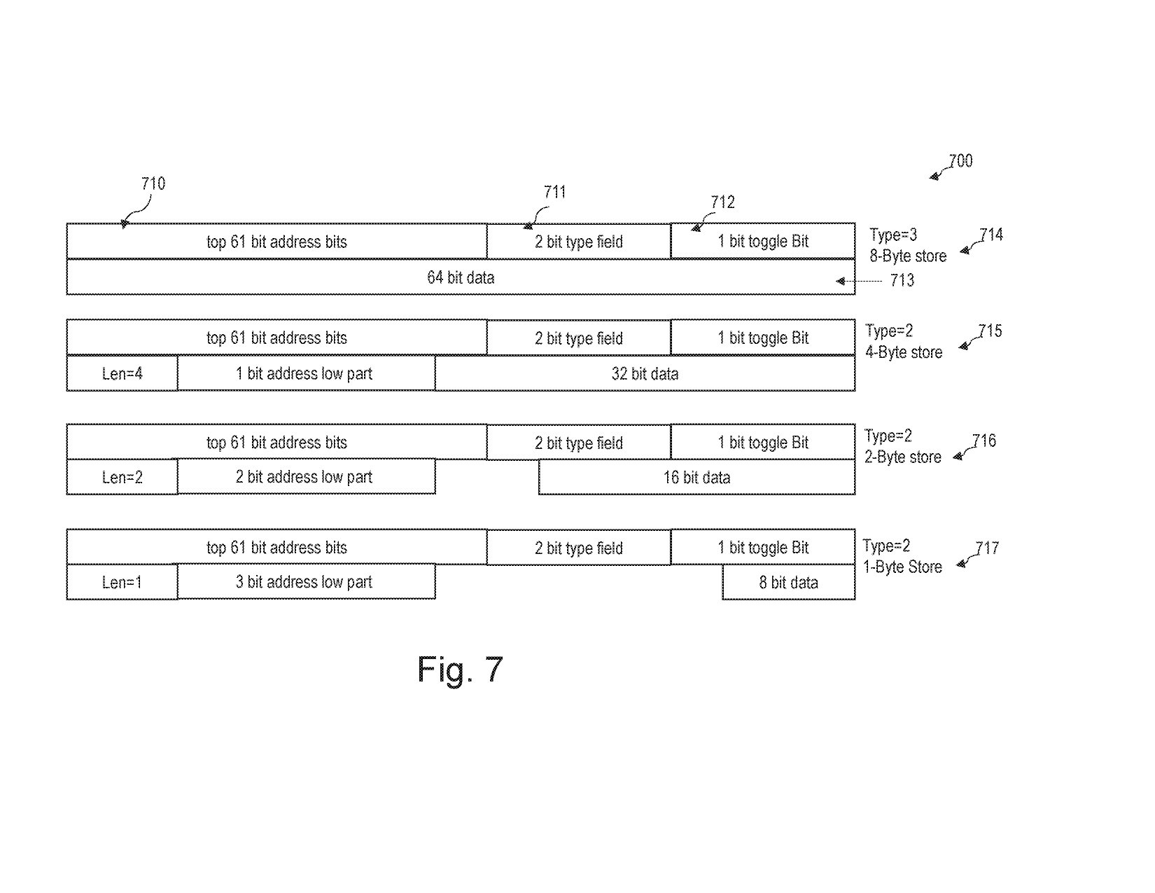

FIG. 7 is a diagram illustrating catchline content 700 of a trigger queue in accordance with an example of the present subject matter

The diagram illustrates various memory storage formats based on the bit size of the data being stored and the length of the data. Each format is composed of a 61-bit address field 710, a 2-bit type field 711, a 1-bit toggle bit 712, and the remaining bits 713 are used for storing the data.

The Type=3 format 714 represents a 64-bit data storage (8-byte store) where the top 61 bits address the upper part of the memory, the 2-bit field specifies the operation type, the 1-bit toggle manages data transaction synchronization, and the final 64 bits store the actual data.

The Type=2 format 715 represents 32-bit data storage (4-byte store) where the top 61 bits address the upper part of memory, the upper 2-bit field specifies the operation type, a 1-bit lower address part differentiates within smaller segments, the 2-bit type field set, the 1-bit toggle bit manages synchronization, and the remaining 32 bits store the actual data.

The other Type=2 716 format represents 16-bit data storage (2-byte store) where the top 61 bits address the upper part of memory, the upper 2-bit field specifies the operation type, a 2-bit lower address part allows for more precise addressing, the 2-bit type field set to 2 indicates a 2-byte store, the 1-bit toggle bit manages synchronization, and the remaining 16 bits store the actual data.

The other Type=2 717 format represents 8-bit data storage (1-byte store) where the top 61 bits address the upper part of memory, the upper 2-bit field specifies the operation type, a 3-bit lower address part allows for more specific addressing, the 2-bit type field set to 2 indicates a 1-byte store, the 1-bit toggle bit manages synchronization, and the remaining 8 bits store the actual data.

The present subject matter may comprise the following clauses.

Clause 1. A method for storing data in a peripheral device, the peripheral device being configured to connect to a processing subsystem through a bus controller, the processing subsystem comprising a processing unit and a memory unit; the method comprising: providing the memory unit with a queue; repeatedly performing by the processing unit: receiving a store instruction to store data in the peripheral device; adding an entry in the queue, the entry representing the store instruction; in response to determining that a trigger condition is fulfilled, enabling the bus controller to access the store instructions being in the queue.

Clause 2. The method of clause 1, wherein enabling access to the store instructions comprises sending a trigger, referred to as a delayed trigger, to the bus controller, thereby trigger the bus controller to fetch the store instructions from the queue.

Clause 3. The method of clause 2, further comprising: upon receiving a first store instruction or a store instruction following the submission of the delayed trigger, setting a timer to a time delay and starting the timer; wherein the trigger condition is an expiration of the timer.

Clause 4. The method of clause 3, further comprising: determining using a fill state indicator whether the queue is full; in response to determining that the queue is full, determining that the timer is prematurely expired for prematurely sending the delayed trigger.

Clause 5. The method of clause 3, the time delay being a preset amount of time or an implicit delay of a communication between the processing unit and the bus controller.

Clause 6. The method of clause 2, the trigger condition being the queue being full.

Clause 7. The method of clause 1, wherein the trigger condition being a reception of a signal from the bus controller, wherein enabling access to the store instructions comprises sending the store instructions to the bus controller.

Clause 8. The method of clause 7, wherein the processing unit is configured to set a first flag indicating a signal is required, wherein the bus controller is configured to set a second flag and send the signal to the processing unit in response to determining that the first flag is set.

Clause 9. The method of clause 8, wherein the processing unit is configured to set the first flag in response to determining that the queue has a filling status below a threshold.

Clause 10. The method of any of the preceding clauses 1 to 9, wherein the processing subsystem comprises multiple bus controllers each being associated with a peripheral device, the method further comprising providing the memory unit with a queue per bus controller, wherein the adding of the entry comprises selecting the queue based on the store instruction.

Clause 11. The method of any of the preceding clauses 1 to 10, wherein the processing subsystem comprises multiple bus controllers each being associated with a peripheral device, wherein the entry further comprises an indication of the peripheral device, and of the bus controller.

Clause 12. The method of any of the preceding clauses 1 to 11, wherein the entry is stored as cacheline in a cache of the memory unit.

Clause 13. The method of any of the preceding clauses 2 to 12, further comprising: in response to receiving the delayed trigger by the bus controller, retrieving store instructions from the queue; forwarding the store instructions to the peripheral device; fetching by the peripheral device data from the memory unit through Direct Memory Access (DMA) requests, and storing the fetched data.

Clause 14. The method of clause 13, further comprising while or after processing the queue, the bus controller updating a fill state indicator of the queue.

Computing environment 800 contains an example of an environment for the execution of at least some of the computer code involved in performing the inventive methods, such as code 900 for storing data in a peripheral device. In addition to block 900, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 900, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 900 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in block 900 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

CLOUD COMPUTING SERVICES AND/OR MICROSERVICES (not separately shown in FIG. 8): private and public clouds are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim.“ A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

What is claimed is:

1. A method for storing data in a peripheral device, the peripheral device being configured to connect to a processing subsystem through a bus controller, the processing subsystem comprising a processing unit and a memory unit, the method comprising:
providing the memory unit with a queue; and
repeatedly performing by the processing unit:
receiving a store instruction to store data in the peripheral device;
adding an entry in the queue, the entry representing the store instruction; and
in response to determining that a trigger condition is fulfilled, enabling the bus controller to access the store instructions being in the queue.

2. The method of claim 1, wherein enabling access to the store instructions comprises sending a delayed trigger to the bus controller, thereby triggering the bus controller to fetch the store instructions from the queue.

3. The method of claim 2, further comprising:
upon receiving a first store instruction or a store instruction following the sending of the delayed trigger, setting a timer to a time delay and starting the timer, wherein the trigger condition is an expiration of the timer.

4. The method of claim 3, further comprising:
determining using a fill state indicator whether the queue is full; and
in response to determining that the queue is full, determining that the timer is prematurely expired for prematurely sending the delayed trigger.

5. The method of claim 3, wherein the time delay is a preset amount of time or an implicit delay of a communication between the processing unit and the bus controller.

6. The method of claim 2, wherein the trigger condition is the queue being full.

7. The method of claim 1, wherein the trigger condition is a reception of a signal from the bus controller, and wherein enabling access to the store instructions comprises sending the store instructions to the bus controller.

8. The method of claim 7, wherein the processing unit is configured to set a first flag indicating a signal is required, and wherein the bus controller is configured to set a second flag and send the signal to the processing unit in response to determining that the first flag is set.

9. The method of claim 8, wherein the processing unit is configured to set the first flag in response to determining that the queue has a filling status below a threshold.

10. The method of claim 1, wherein the processing subsystem comprises multiple bus controllers each being associated with a peripheral device, the method further comprising providing the memory unit with a queue per bus controller, wherein the adding of the entry comprises selecting the queue based on the store instruction.

11. The method of claim 1, wherein the processing subsystem comprises multiple bus controllers each being associated with a peripheral device, and wherein the entry further comprises an indication of the peripheral device, and of the bus controller.

12. The method of claim 1, wherein the entry is stored as cacheline in a cache of the memory unit.

13. The method of claim 2, further comprising:
in response to receiving the delayed trigger by the bus controller:
retrieving store instructions from the queue;
forwarding the store instructions to the peripheral device; and
fetching by the peripheral device data from the memory unit through Direct Memory Access (DMA) requests, and storing the fetched data.

14. The method of claim 13, further comprising while or after processing the queue, the bus controller updating a fill state indicator of the queue.

15. A computer program product for storing data in a peripheral device, the peripheral device being configured to connect to a processing subsystem through a bus controller, the processing subsystem comprising a processing unit and a memory unit, the memory unit comprising a queue, the computer program product comprising a computer readable storage medium having computer readable program code embodied therewith, the computer readable program code executable by a system to cause the system to perform a method comprising:
repeatedly performing by the processing unit:
receiving a store instruction to store data in the peripheral device;
adding an entry in the queue, the entry representing the store instruction; and
in response to determining that a trigger condition is fulfilled, enabling the bus controller to access the store instructions being in the queue.

16. A processing unit for a computer system for storing data in a peripheral device, the peripheral device being configured to connect through a bus controller to the processing unit, the computer system comprising the bus controller, the processing unit and a memory unit, the memory unit comprising a queue; the processing unit being configured for:
repeatedly:
receiving a store instruction to store data in the peripheral device;
adding an entry in the queue, the entry representing the store instruction; and
in response to determining that a trigger condition is fulfilled, enabling the bus controller to access the store instructions being in the queue.

17. The processing unit of claim 16, wherein the processing unit is further configured to receive a signal from the bus controller, wherein the trigger condition is the receiving of the signal.

18. The processing unit of claim 16, comprising a timer, the processing unit further configured to: upon receiving a first store instruction or a store instruction following a sending of a delayed trigger, set the timer to a time delay and start the timer, wherein the trigger condition is an expiration of the timer.

19. The processing unit of claim 18, wherein the time delay is a preset amount of time or an implicit delay of a communication between the processing unit and the bus controller.
